(19) United States
(12) Patent Application Publication
(10) Pub. No.: US 2026/0064890 A1
(43) Pub. Date: Mar. 5, 2026

(54) Training Data Provenance System and Method

(71) Applicant: Microsoft Technology Licensing, LLC, Redmond, WA (US)

(72) Inventors: Mark Russinovich, Redmond, WA (US); Bryan D. Kelly, Redmond, WA (US)

(21) Appl. No.: 18/905,914

(22) Filed: Oct. 3, 2024

Related U.S. Application Data
(60) Provisional application No. 63/690,114, filed on Sep. 3, 2024.

(51) Int. Cl. G06F 21/64; G06F 21/60

(52) U.S. Cl. CPC G06F 21/64; G06F 21/602

(57) ABSTRACT

A method, computer program product, and computing system for generating signed data for training an artificial intelligence (AI) model by processing data stored on a ledger using a signing authority. Signed firmware is generated for training the AI model by processing data stored on the ledger using the signing authority. The AI model is trained with signed data and the signed firmware from the ledger using a data processing unit in response to determining that the signed data and the signed firmware are signed by the signing authority.

### RELATED CASES

This application claims the benefit of U.S. Provisional Application No. 63/690,114 filed on 3 Sep. 2024, the contents of which are all incorporated by reference.

### BACKGROUND

Provenance in Artificial Intelligence (AI) refers to the ability to trace the origin, development, and deployment of AI models and their associated data throughout their lifecycle. It encompasses tracking the entire history of a model, including its training data, the algorithms used, and any modifications or optimizations applied during development. Provenance is crucial for ensuring transparency, accountability, and reproducibility in AI systems. It allows stakeholders to understand how a model was created, what data it was trained on, and how it makes decisions, which is essential for auditing, debugging, and mitigating biases or errors. By capturing and documenting the provenance of AI models, organizations can enhance trust in AI systems, comply with regulatory requirements, and address ethical concerns related to AI deployment. Provenance tracking tools and techniques include metadata annotation, version control systems, and blockchain technology, which enable comprehensive documentation and validation of AI model lineage and history.

When training an AI model, it is critical to ensure the provenance of the data with which the model is trained. Version control systems and blockchain ledger technology may be used to track the origin, development, and deployment of AI models. However, such ledger systems are “honors-based,” meaning that the information placed on the ledger is at the discretion of the user of the system and the integrity of the data placed on the ledger is not guaranteed to be correct. Further, such systems are not necessarily run in confidential compute environments, placing the information and the integrity of the models at risk.

### BRIEF DESCRIPTION OF THE DRAWINGS

FIG. 1 is a flow chart of an implementation of a training data provenance process;

FIG. 2 is a diagrammatic view of an implementation of the training data provenance process of FIG. 1;

FIG. 3 is a flow chart of an implementation of the training data provenance process of FIG. 1; and

FIG. 4 is a diagrammatic view of a computer system and the training data provenance process coupled to a distributed computing network.

Like reference symbols in the various drawings indicate like elements.

### DETAILED DESCRIPTION OF THE EMBODIMENTS

As will be discussed in greater detail below, implementations of the present disclosure maintain provenance and integrity of AI training data. For example, provenance of AI training data is a key security attribute for trusting the integrity of the model weights used to train a model. At a top level, the end-to-end integrity for robust AI security spans four dimensions:
The integrity of the model, including code, compilers, and algorithms used in training;
The integrity of model weights and configuration during training;
The integrity of the infrastructure is used to train the model; and
The integrity of data that is used to train the model.

Ensuring training data provenance in AI models involves tracking and documenting the origin, history, and processing of the data used to train the models. This process is crucial for maintaining the integrity, reliability, and ethical standards of AI systems. Provenance can be ensured through several key practices. First, it is essential to maintain comprehensive records of data sources. This includes detailed information about where the data was obtained, whether it is from publicly available datasets, proprietary sources, or data collected specifically for the project. Documentation should also capture any licenses or permissions associated with the data to ensure legal compliance. Second, implementing robust data management and version control systems is vital. These systems should log every modification or transformation applied to the data, including cleaning, preprocessing, and augmentation steps. Each version of the dataset should be saved and referenced with unique identifiers, allowing for traceability and reproducibility of the training process. Third, leveraging metadata standards and tools can enhance data provenance. Metadata should include information about the data's structure, content, and context, as well as the methods and tools used to collect and process it. Tools such as data lineage tracking software can automatically document and visualize the data's journey from its source to its final form used in model training. Furthermore, establishing clear and transparent protocols for data handling is crucial. This includes setting guidelines for data acquisition, storage, access, and sharing. Regular audits and reviews of data handling practices can help identify and mitigate potential risks or breaches in data provenance.

The training data provenance process creates protected and attested trusted execution environments (TEEs). An autonomous ledger runs inside the TEE and records artifacts in chronological order. For example, artifacts stored in a ledger (e.g., a data structure or other database) can be pre-verified for inclusion in the ledger such that subsequent uses of the artifact can be traced to the ledger. A signing authority (with public-private key cryptography) runs within the TEE, in which the private key is only known to the signing authority, and only signs artifacts that have been recorded on the ledger. For example, each artifact (e.g., data, firmware, and/or hardware identifier) is signed using by the signing authority when that artifact is properly stored in the ledger. Further, the training data provenance process executes code on hardware that has been signed by the signing authority used in the model training process. Accordingly, the training data provenance process provides a combined hardware-based confidential computing security structure and a cryptographic ledger-based function of a Code Transparency Service (CTS) to provide unique security attributes for end-to-end identity and provenance of model training data.

The details of one or more implementations are set forth in the accompanying drawings and the description below. Other features and advantages will become apparent from the description, the drawings, and the claims.

### The Training Data Provenance Process:

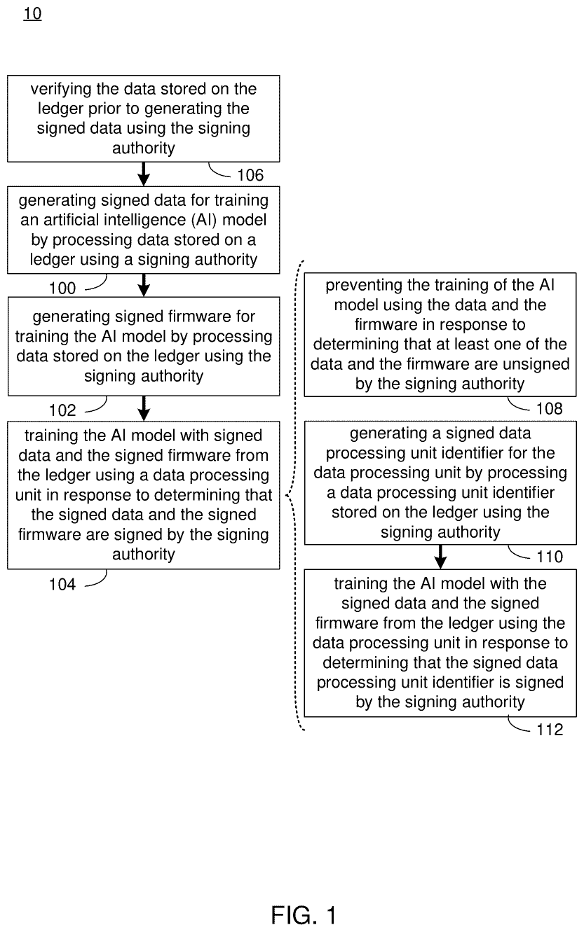

Referring to FIGS. 1-3, training data provenance process 10 generates 100 signed data for training an artificial intelligence (AI) model by processing data stored on a ledger using a signing authority. Signed firmware is generated 102 for training the AI model by processing data stored on the ledger using the signing authority. The AI model is trained 104 with signed data and the signed firmware from the ledger using a data processing unit in response to determining that the signed data and the signed firmware are signed by the signing authority.

In some implementations, training data provenance process 10 enables a Code Transparency Service (CTS), which is a platform that provides visibility into the codebase of software projects. For example, a CTS includes features such as code scanning, analysis, and monitoring to ensure that the code meets certain standards of quality, security, and compliance. These services allow users to gain insights into the codebase, identify potential issues or vulnerabilities, and track changes over time. By providing transparency into the code, these services help improve collaboration, detect and fix problems early in the development process, and ensure that the final product is reliable, secure, and maintainable. In some implementations, the CTS provides a confidential ledger that runs autonomously. A unique attribute of the CTS, beyond standard blockchain technologies, is that administrators and operators of a CTS instance are not in the Trusted Computing Base (TCB) for the ledger (which is different from other ledger technologies).

In some implementations, the CTS performs computations within a hardware-backed Trusted Execution Environment (TEE), which shields code and data from observation or modification by privileged software such as hypervisor and system firmware. A TEE is a secure and isolated environment within a processor that provides a high level of security for executing sensitive code and protecting confidential data. In some implementations, the TEE safeguards against various threats, including unauthorized access, tampering, and side-channel attacks, by creating a secure enclave that is isolated from the rest of a target computing system. These enclaves typically rely on hardware-based security features to establish the TEE that is immune to software-based attacks. Within a TEE, applications can run in a protected space where code and data are encrypted and shielded from the underlying operating system, hypervisor, and other software layers. This ensures that even if the underlying system is compromised, the sensitive information within the enclave remains secure. TEEs provide a secure foundation for a wide range of use cases, including secure key storage, cryptographic operations, digital rights management, and secure enclaves for executing sensitive workloads in cloud computing environments.

In one example, the TEE is a confidential virtual machine. In another example, the TEE is a GPU or other hardware device. In such cases, the security protocols for confidential computing provide cryptographic evidence of TEE integrity, which are endorsed by the hardware root of trust. This evidence is further endorsed by being recorded on the CTS, by the TEE. The ledger endorsement further provides chronology and provenance.

Cryptographic digests, also known as hash functions or hash values, are used for ensuring data integrity and authenticity. These digests are one-way functions that take an input (often a message or data file) and produce a fixed-size output, typically represented as a string of characters. The key properties of cryptographic digests include collision resistance, meaning it's computationally infeasible to find two different inputs that produce the same hash value, and preimage resistance, which means it's computationally infeasible to reverse-engineer the original input from the hash value. Cryptographic digests are widely used in various security applications, including digital signatures and data integrity verification. For instance, in digital signatures, a hash value of the message is generated and then encrypted with the sender's private key. The recipient can verify the integrity and authenticity of the message by decrypting the signature using the sender's public key and comparing the resulting hash value with the one calculated from the received message. Further, cryptographic digests of model weights produced by the training algorithms are recorded on the CTS ledger.

While blockchain involves a common ledger operation, it is insufficient to provide robust provenance on AI models and data used to train AI models. If the operators of a blockchain service are in the trusted computing base, the service hosting software and infrastructure, in addition to the AI infrastructure, needs to be trusted. However, trust in blockchain cannot be verified, for example, for ensuring that only data recorded on the blockchain was used to train the model and that all data that was used to train the model is included in the blockchain. In other words, given the non-secure nature of blockchain data recording, provenance of information regarding the data used to train a model stored on a blockchain cannot be trusted.

In accordance with implementations of the present disclosure, confidential compute technology provides trusted hardware isolated environments that are fully attested with cryptographic evidence of integrity. The CTS has similar ledger attributes to a blockchain, with the distinction that CTS itself executes within confidential compute environment and runs autonomously, removing administrators, operators and unattested hardware and software from its TCB.

Implementations of the present disclosure provide trust to the base models trained in the system, as they will have endorsement of the underlying model. They will also provide trust to the training data, as provenance of the training data is tracked in the CTS. Users can also trust derivative models trained over these base models when they use their data, since the system provides cryptographic proof that only their data has been appended to the trusted base model.

As described above, the CTS is an autonomous process, which is a service that is completely self-governing and controls its own data. It denies outside access to its data or its objects. In one example, interacting with an autonomous application includes sending the application a message requesting the application to perform a task. If the application does not approve the request or the requester, it can refuse to perform it.

In some implementations, the CTS provides users of confidential services that have code implemented by and managed by another party, such as a cloud provider, assurances that confidential service code adheres to policies required for trust. A fundamental policy is that a complete record of the confidential code (and configuration relevant to enforcing confidentiality) is recorded such that a customer can audit it, including inspecting the source code, if they suspect the code could or has leaked their data, thereby violating the confidentiality guarantee. As such an instance of CTS is the root of trust for a Confidential Trust Boundary (CTB) upon which other confidential services in the CTB rely.

In some implementations, training data provenance process 10 stores an artifact on a ledger. An artifact is data, firmware, and/or hardware identifier information. In one example, an artifact describes training data for an AI model. In another example, an artifact references firmware that is used by a data processing unit (e.g., a GPU). In another example, an artifact includes information that identifies a particular hardware component (e.g., individual GPU or other data processing unit). In this manner, artifacts can represent data to be used during training of an AI model, the firmware executed by a GPU to train the AI model, and/or identifier information for the GPUs training the AI model. Accordingly and as will be discussed in greater detail below, training data provenance process 10 uses the artefacts to individually certify the data, firmware, and/or hardware for training AI models and/or during other data processing tasks.

In some implementations, training data provenance process 10 verifies 106 the data stored on the ledger prior to generating the signed data using the signing authority. For example, training data provenance process 10 performs predefined data verification or validation processes on each artifact before storing the artifact to the ledger. In one example, training data provenance process 10 employs separate verification of artifacts based on each artifact type (e.g., training data, firmware, hardware identifier, etc.).

In some implementations, training data provenance process 10 generates 100 signed data for training an artificial intelligence (AI) model by processing data stored on a ledger using a signing authority. For example, training data provenance process 10 stores the artifacts in a ledger (i.e., a data structure or database that stores data with a record of when the data is added to and/or removed from the ledger). In one example, suppose training data provenance process 10 includes training data for an AI model. In this example, the training data is an artifact that is stored in the ledger. To provide provenance for the training data, training data provenance process 10 generates signed data by processing the training data stored in the ledger using a signing authority. Signed data is data with a digital signature indicating that the data has been processed by a signing authority. A signing authority is a hardware and/or software component that determines whether an artifact can or cannot be validly signed. For example, the signing authority may sign any and all data within the ledger. In another example, the signing authority may be limited to certain types of signatures for specific types of artifacts (e.g., a signing authority for training data of a particular AI model; a signing authority for firmware used by particular data processing units; and a signing authority for specific hardware devices). Accordingly, it will be appreciated that any number of signing authorities can provide various signatures within the scope of the present disclosure.

In some implementations, training data provenance process 10 has a signing service extension, where only verified artifacts recorded on the ledger are signed. For example and as discussed above, in response to verifying the data integrity of an artifact, training data provenance process 10 signs the artifact stored on the ledger using the signing authority by generating signed data using the signing authority. In some implementations, this verification is used for enforcing the use of the ledger because the integrity protection in software and hardware relies on a digital signature. In some implementations and as will be discussed in greater detail below, training data provenance process 10 has a unique signing key (e.g., only the signing authority has access to a private key to sign objects) and will only sign if the artifact(s) are recorded on the ledger.

In some implementations, training data provenance process 10 generates 102 signed firmware for training the AI model by processing data stored on the ledger using the signing authority. For example and as with training data above, training data provenance process 10 provide provenance for the firmware by generating signed firmware using firmware stored in the ledger and the signing authority. In this example, with signed firmware, training data provenance process 10 provides provenance for training data and firmware used to train an AI model using particular data processing units (e.g., GPUs) such that each element (e.g., the training data and the firmware) can be separately sourced and validated for a particular application (e.g., AI model training).

In some implementations, training data provenance process 10 trains 104 the AI model with signed data and the signed firmware from the ledger using a data processing unit in response to determining that the signed data and the signed firmware are signed by the signing authority. For example, training data provenance process 10 processes 104 the artifact stored on the ledger with one or more graphical processing units (GPUs) by only processing artifacts from the ledger that have been signed by the signing authority. In one example, training data provenance process 10 uses a GPU (or set of GPUs) to perform training of an AI model. However, to ensure that the training data and/or the firmware used by the GPU during AI model training is consistent, training data provenance process 10 determines whether the training data and/or the firmware is signed by signing authority. If the artifacts are signed, training data provenance process 10 proceeds to train the AI model with the signed data and signed firmware from the ledger.

In some implementations and in response to determining that at least one of the data and the firmware are unsigned (i.e., not signed) by the signing authority, training data provenance process 10 prevents 108 the training of the AI model using the data and the firmware. In this manner, training data provenance process 10 prevents the AI model from being trained using unsigned data and/or unsigned firmware associated with the training of the AI model.

In some implementations, training data provenance process 10 generates 110 a signed data processing unit identifier for the data processing unit by processing a data processing unit identifier stored on the ledger using the signing authority. For example, confidential hardware devices associated with the data processing units (e.g., GPUs) have unique cryptographic hardware identity. Confidential hardware devices that run in a hosted environment have their identity recorded/registered in CTS. For example, training data provenance process 10 trains 112 the AI model with the signed data and the signed firmware from the ledger using the data processing unit in response to determining that the signed data processing unit identifier is signed by the signing authority. Accordingly, hardware is fused with the public portion of a CTS signing key (from the signing authority), will only run code that has been digitally signed by the CTS private key of the signing authority.

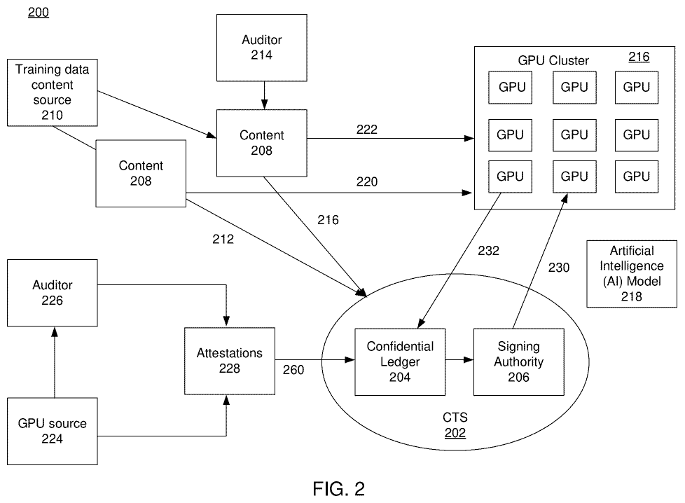

Referring also to FIG. 2, within trusted execution environment (TEE) 200, code transparency services 202 includes a confidential ledger 204 and a confidential signing authority 206. In one example, artifacts or content (e.g. training data content 208), including refined training data, is directly recorded on ledger 204 from data source 210 (as shown by arrow 212). In another example, content 208 is verified (as discussed above and/or by an auditing system or auditing user (e.g., auditor 214) to confirm its integrity prior to it being recorded on ledger 204 (as shown by arrow 214). In another example, content 208 is input directly to GPU cluster 214 (i.e., GPU cluster 216 includes a number of GPUs for processing data 208 for training an AI model (e.g., AI model 218)) (as shown by arrow 220) or after verification (as shown by arrow 222). Device identities of the GPUs in GPU cluster 214 are ascribed when the GPUs are manufactured by a GPU manufacturer or other source (e.g., GPU source 224), as well as firmware to be run thereon. Device identities, builds, and firmware are reviewed (e.g., by an auditor 226, which is a trusted third party), and attestations 228 concerning the GPU are recorded on the ledger 204.

As described in greater detail below, only firmware that is signed is allowed to be run on GPU cluster 216. In one example, when the firmware is to be recorded on the ledger 204, only firmware on the ledger including attestations 228 will be signed by signing authority 210. Accordingly, any firmware that has not been audited and provided with attestation 228 will not be run on GPU cluster 216. This prevents unauthorized firmware from being utilized in the training of AI models (e.g., AI model 218) within TEE 200.

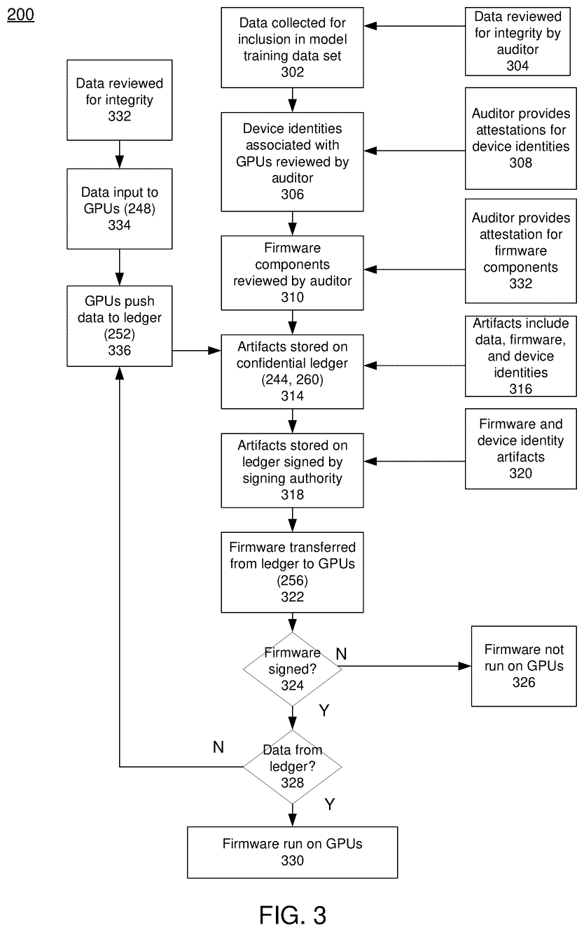

Referring also to FIG. 3, which is a flowchart (e.g., flowchart 300) depicting an example embodiment of training data provenance process 10 taking place within TEE 200, content 208 for inclusion in AI model training data is collected (e.g., shown as action 302). In an embodiment, the data 208 is reviewed for integrity by an auditor 214 (e.g., shown as action 304). Device identities associated with the GPUs in the GPU cluster 216 are reviewed by an auditor (e.g., auditor 226) (e.g., shown as action 306). In some implementations, the auditing system or auditing user (e.g., auditor 226) provides attestations 228 for the device identities (e.g., shown as action 308). In some implementations, firmware components are also reviewed by auditor 226 (e.g., shown as action 310) and attestations 228 for the firmware are provided by the auditing system or auditing user (e.g., auditor 226) (e.g., shown as action 312).

In some implementations, training data provenance process 10 records artifacts on the confidential ledger 204 of the CTS 202 (e.g., shown as action 314). As discussed above, artifacts include any byproducts or outputs that are created during the software development process. These can include a wide range of items such as code, documentation, diagrams, models, and configuration files. Artifacts play a crucial role in the development lifecycle as they provide essential information and resources needed for building, testing, and maintaining software systems. For example, source code is an artifact that developers write to implement functionality, while documentation artifacts might include user manuals and technical specifications that help in understanding and using the software. As discussed above and in some implementations, artifacts include data, firmware, and device identities (e.g., shown as 316). In some implementations, only a cryptographic digest of each artifact is stored in the ledger 206.

As described above, the cryptographic digest may include a hash of the artifacts. In one example, the hash includes a SHA384 hash of each artifact. SHA-384, or Secure Hash Algorithm 384, is a cryptographic hash function belonging to the SHA-2 (Secure Hash Algorithm 2) family. It generates a fixed-size output of 384 bits, or 48 bytes, regardless of the input size. SHA-384 is designed to provide a high level of security and resistance against various cryptographic attacks. It operates by taking an input message and processing it through a series of mathematical operations, resulting in a unique hash value that serves as a digital fingerprint for the input data. This hash value is typically represented as a hexadecimal string. SHA-384 is commonly used in security protocols, digital signatures, and other applications where data integrity and authenticity are paramount. While one example of a cryptographic hash function has been described, it will be appreciated that any cryptographic hash function may be used within the scope of the present disclosure.

In some implementations, certain artifacts recorded on ledger 204 are signed by signing authority 206 (shown as action 318). For example, the artifacts signed by the signing authority 206 include the firmware and device identities that have been attested to by the auditor 226 (e.g., shown as action 320). In one example, the signing authority 206 uses public private key cryptography, in which the signing authority 206 includes the private key and firmware authorization is performed with the public key. This enables the firmware to be signed by the signing authority 206.

Firmware recorded on ledger 204 is then transferred (shown by arrow 230) to GPU cluster 216 (e.g., shown as action 322). In one example, if the firmware has not been signed by the signing authority 206 (e.g., determination action shown as action 324), training data provenance process 10 prevents 108 the training of AI model 218 using the unsigned on GPU cluster 216 (e.g. shown as action 326). This prevents AI model 218 being trained from training with unauthorized firmware and also contributes to provenance by ensuring that only attested to firmware is run on GPU cluster 216. By keeping a record of all firmware that is used to train AI model 218, the integrity of the AI model training data can be maintained and tracked.

In another example, if the firmware transferred to GPU cluster 216 is signed (determination action shown by action 324), GPU cluster 216 determines whether the data being used to train AI model 218 was recorded on ledger 204 (e.g., shown as action 328). In some implementations, if it was recorded on the ledger, the firmware is run on GPU cluster 216 to train AI model 218 using the data recorded on the ledger (e.g., shown as action 330). This ensures that only authorized and attested to firmware and data that are recorded on the ledger is used to train AI model 218. If GPU cluster 216 determines that the data was received and not recorded on the ledger 204 (e.g., determination action shown by action 328), it pushes (shown by arrow 230) the data to ledger 204 (e.g., shown by action 336), which is then stored on the ledger 204 (e.g., shown by action 314). In this manner, provenance of the data used to train AI model 218 is preserved, since only data recorded on the ledger will be used by GPU cluster 216 to train AI model 218. Further, in the example where data reviewed by the auditor 214 (e.g., shown by action 332), is transferred from data source 210 to GPU cluster 216 (shown by action 334), GPU 216 pushes that data to ledger 204, to preserve the provenance of the data as described above. This ensures that the user of the system for the training of AI model 218 can refer to the ledger to determine the data, firmware, and hardware used to train the model.

Accordingly, training data provenance process 10 ensures that all data, firmware, and device identifications are recorded on a confidential ledger such that the integrity of the components used to train a model are irrefutable and easily proven. Further, by requiring that the system hardware only run firmware that has been recorded on the confidential ledger and signed by the signing authority, the provenance of the integrity of the trained model is maintained.

### System Overview:

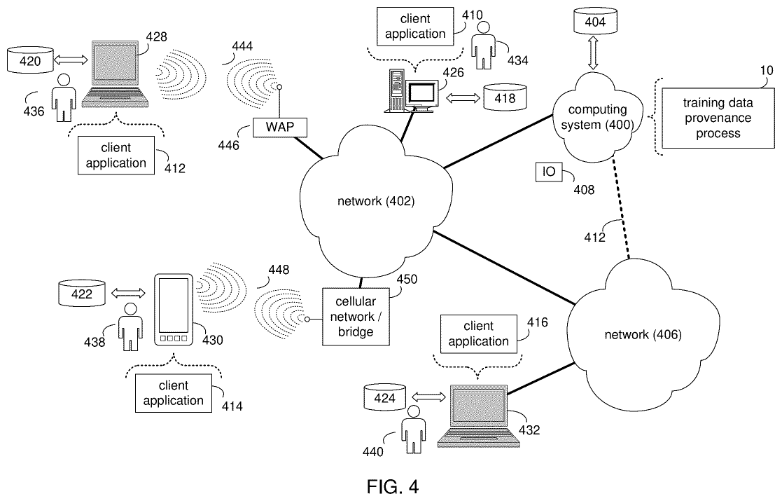

Referring to FIG. 4, a training data provenance process 10 is shown to reside on and is executed by computing system 400, which is connected to network 402 (e.g., the Internet or a local area network). Examples of computing system 400 include: a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of computing system 400 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of training data provenance process 10, which are stored on storage device 404 included within computing system 400, are executed by one or more processors (not shown) and one or more memory architectures (not shown) included within computing system 400. Storage device 404 may include: a hard disk drive; an optical drive; a RAID device; a random-access memory (RAM); a read-only memory (ROM); and all forms of flash memory storage devices. Additionally or alternatively, some portions of the instruction sets and subroutines of training data provenance process 10 are stored on storage devices (and/or executed by processors and memory architectures) that are external to computing system 400.

In some implementations, network 402 is connected to one or more secondary networks (e.g., network 406), examples of which include: a local area network; a wide area network; or an intranet.

Various input/output (IO) requests (e.g., IO request 408) are sent from client applications 410, 412, 414, 416 to computing system 400. Examples of IO request 408 include data write requests (e.g., a request that content be written to computing system 400) and data read requests (e.g., a request that content be read from computing system 400).

The instruction sets and subroutines of client applications 410, 412, 414, 416, which may be stored on storage devices 418, 420, 422, 424 (respectively) coupled to client electronic devices 426, 428, 430, 432 (respectively), may be executed by one or more processors (not shown) and one or more memory architectures (not shown) incorporated into client electronic devices 426, 428, 430, 432 (respectively). Storage devices 418, 420, 422, 424 may include: hard disk drives; tape drives; optical drives; RAID devices; random access memories (RAM); read-only memories (ROM), and all forms of flash memory storage devices. Examples of client electronic devices 426, 428, 430, 432 include personal computer 426, laptop computer 428, smartphone 430, laptop computer 432, a server (not shown), a data-enabled, and a dedicated network device (not shown). Client electronic devices 426, 428, 430, 432 each execute an operating system.

Users 434, 436, 438, 440 may access computing system 400 directly through network 402 or through secondary network 406. Further, computing system 400 may be connected to network 402 through secondary network 406, as illustrated with link line 442.

The various client electronic devices may be directly or indirectly coupled to network 402 (or network 406). For example, personal computer 426 is shown directly coupled to network 402 via a hardwired network connection. Further, laptop computer 432 is shown directly coupled to network 406 via a hardwired network connection. Laptop computer 428 is shown wirelessly coupled to network 402 via wireless communication channel 444 established between laptop computer 428 and wireless access point (e.g., WAP) 446, which is shown directly coupled to network 402. WAP 446 may be, for example, an IEEE 802.11a, 802.11b, 802.11g, 802.11n, Wi-Fi®, and/or Bluetooth® device that is capable of establishing a wireless communication channel 444 between laptop computer 428 and WAP 446. Smartphone 430 is shown wirelessly coupled to network 402 via wireless communication channel 448 established between smartphone 430 and cellular network/bridge 450, which is shown directly coupled to network 402.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this A computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
generating signed data for training an artificial intelligence (AI) model by processing data stored on a ledger using a signing authority;
generating signed firmware for training the AI model by processing data stored on the ledger using the signing authority; and
training the AI model with signed data and the signed firmware from the ledger using a data processing unit in response to determining that the signed data and the signed firmware are signed by the signing authority.

2. The computer-implemented method of claim 1, wherein training the AI model includes preventing the training of the AI model using the data and the firmware in response to determining that at least one of the data and the firmware are unsigned by the signing authority.

3. The computer-implemented method of claim 1, wherein the data processing unit is a graphics processing unit (GPU).

4. The computer-implemented method of claim 1, further comprising:
verifying the data stored on the ledger prior to generating the signed data using the signing authority.

5. The computer-implemented method of claim 1, further comprising:
generating a signed data processing unit identifier for the data processing unit by processing a data processing unit identifier stored on the ledger using the signing authority.

6. The computer-implemented method of claim 5, wherein training the AI model includes training the AI model with the signed data and the signed firmware from the ledger using the data processing unit in response to determining that the signed data processing unit identifier is signed by the signing authority.

7. The computer-implemented method of claim 1, wherein the signing authority uses public private key cryptography for generating the signed data and the signed firmware.

8. A computer program product residing on a non-transitory computer readable medium having a plurality of instructions stored thereon which, when executed by a processor, cause the processor to perform operations comprising:
verifying data stored on a ledger for training an artificial intelligence (AI) model;
generating signed data for training the AI model by processing the data stored on a ledger using a signing authority;
generating signed firmware for training the AI model by processing data stored on the ledger using the signing authority; and
training the AI model with signed data and the signed firmware from the ledger using a data processing unit in response to determining that the signed data and the signed firmware are signed by the signing authority.

9. The computer program product of claim 8, wherein training the AI model includes preventing the training of the AI model using the data and the firmware in response to determining that at least one of the data and the firmware are unsigned by the signing authority.

10. The computer program product of claim 8, wherein the data processing unit is a graphical processing unit (GPU).

11. The computer program product of claim 8, wherein the operations further comprise:
generating a signed data processing unit identifier for the data processing unit by processing a data processing unit identifier stored on the ledger using the signing authority.

12. The computer program product of claim 11, wherein training the AI model includes training the AI model with the signed data and the signed firmware from the ledger using the data processing unit in response to determining that the signed data processing unit identifier is signed by the signing authority.

13. The computer program product of claim 8, wherein the signing authority uses public private key cryptography for generating the signed data and the signed firmware.

14. The computer program product of claim 13, wherein the signing authority includes a private key and the data processing unit includes a corresponding public key.

15. A computing system comprising:
a memory; and
a processor configured to:
generate signed data for training an artificial intelligence (AI) model by processing data stored on a ledger using a signing authority;
generate signed firmware for training the AI model by processing data stored on the ledger using the signing authority; and
train the AI model with signed data and the signed firmware from the ledger using a graphical processing unit (GPU) in response to determining that the signed data and the signed firmware are signed by the signing authority.

16. The computing system of claim 15, wherein training the AI model includes preventing the training of the AI model using the data and the firmware in response to determining that at least one of the data and the firmware are unsigned by the signing authority.

17. The computing system of claim 15, further comprising:
verifying the data stored on the ledger prior to generating the signed data using the signing authority.

18. The computing system of claim 15, further comprising:
generating a signed data processing unit identifier for the data processing unit by processing a data processing unit identifier stored on the ledger using the signing authority.

19. The computing system of claim 18, wherein training the AI model includes training the AI model with the signed data and the signed firmware from the ledger using the data processing unit in response to determining that the signed data processing unit identifier is signed by the signing authority.

20. The computing system of claim 15, wherein the signing authority uses public private key cryptography for generating the signed data and the signed firmware.
